(19) United States
(12) Patent Application Publication
(10) Pub. No.: US 2007/0152120 A1
(43) Pub. Date: Jul. 5, 2007

(54) Portable gas tank holder with quick-adjustable bracket

(76) Inventor: Paul E. Hostetler, Nokomis, FL (US)

Correspondence Address: BUCHANAN, INGERSOLL & ROONEY PC, POST OFFICE BOX 1404, ALEXANDRIA, VA, 22313-1404, US

(21) Appl. No.: 11/319,441

(22) Filed: Dec. 29, 2005

(51) Int. Cl. F16B 47/00

(52) U.S. Cl. 248/206.3

(57) ABSTRACT

A gas-tank holder for securing at least one element such as a cylindrical compressed gas tank to a support surface includes a frame securable to the support surface by suction cups, and at least one bracket slidably mounted in the frame. The bracket includes first and second bracket parts arranged to form together a receiving pocket. The bracket parts are movable toward and away from one another in order to adjust the size of the pocket. A locking mechanism for coupling the first and second arms together in their adjusted position is releasable while those arms are mounted in the frame. The suction cups are independently swingable relative to the frame to enable the suction cups to engage respective support surface sections that are non-co-planar.

### RELATED INVENTIONS

This invention is related to inventions disclosed in copending application Ser. Nos. 10/960,686 and 29/214,756, both filed Oct. 8, 2004.

### BACKGROUND OF THE INVENTION

The present invention relates to a holder for securing in place portable cylindrical compressed gas tanks, such as the type used in medical or scuba diving applications for example.

Scuba divers, as they are being transported to a dive site (usually by boat) typically do not wear their air tanks, as they are heavy and cumbersome out of water. It is undesirable for the tanks to be able to roll around on the boat's deck, as they can become damaged and pose a hazard. For that reason, some boats are equipped with scuba tank holders affixed to the boat hull, which can safely secure the scuba tanks in place (e.g., see U.S. Pat. No. 5,533,701). However, since not all boats are so equipped, a diver cannot always be confident that his or her tanks will be safely secured during transport to a dive site.

U.S. Pat. No. 5,533,701 discloses a tank holder in the form of a rail that can be screwed to the wall of a boat. Slidably disposed in the rail is at least one bracket having a pair of arms defining a tank-receiving pocket. The arms of each bracket are releasably secured together by interlocking teeth. By releasing the arms (teeth) from one another, the arms can be displaced farther apart or closer together before resecuring the teeth. In that way, the size of the pocket can be adjusted to accommodate larger or smaller tanks. In order to release the arms from one another, however, it is necessary to remove the bracket(s) from the rail, which can be time consuming and possibly difficult if the bracket(s) has become tightly engaged within the rail.

Furthermore, in the inventor's copending application Ser. No. 10/960,686, filed Oct. 8, 2004, there is disclosed a portable gas tank holder which includes a frame carrying at least one bracket that forms a gas tank-receiving pocket, and suction cups attached to respective ends of the frame for securing the frame to a surface. The need to remove a bracket from the frame in order to adjust its size would entail the task of removing one of the suction cups.

Therefore, it would be desirable to provide a tank holder in which the size of the tank-holder bracket(s) could be adjusted without removing the bracket from the frame (rail).

Also, it will be appreciated that some surfaces to which the suction cups are to be attached are not planar. Boat hulls, for example are curved, which means that the surface portions to which the respective suction cups are to be attached are not co-planar. Thus, it may be difficult to provide a secure attachment of the suction cups, whose suction faces are co-planar.

Accordingly, it would also be desirable to provide a suction-held tank holder which can be reliably secured to curved surfaces.

### SUMMARY OF THE INVENTION

One aspect of the present invention relates to a gas tank holder for securing at least one cylindrical compressed gas tank to a support surface. The holder comprises a frame securable to the support surface, at least one bracket slidably mounted in the frame, and at least one suction cup attached to the frame for removably securing the frame to the support surface. The bracket includes first and second arms arranged to form together a tank-receiver pocket. The arms are arranged for movement toward and away from one another while mounted in the frame, to adjust the size of the pocket. A locking mechanism is provided for coupling the first and second arms together in their adjusted position. The locking mechanism is releasable while the first and second arms are mounted in the frame to enable the first and second arms to be adjusted.

Preferably, the locking mechanism comprises a spring finger disposed on the first arm and having first teeth formed thereon. The spring finger is biased elastically toward second teeth formed on the second arm.

In another aspect of the present invention, the suction cups are independently swingable relative to the frame and relative to one another to enable the suction cups to be attached to respective support surface sections that are in non-co-planar relationship.

In another aspect of the invention, first and second clip-on members are arranged to be clipped onto first and second arms, respectively, of the bracket for reducing a size of the pocket.

### BRIEF DESCRIPTION OF THE DRAWINGS

The objects and advantages of the invention will become apparent from the following detailed description of preferred embodiments thereof in connection with the accompanying drawings in which like numerals designate like elements.

FIG. 1 is a bottom perspective view of a portable gas tank holder according to the invention when mounted on a support surface having non co-planar surface sections.

FIG. 2 is a rear elevational view of FIG. 1.

FIG. 3 is a top plan view of FIG. 1.

FIG. 4 is a perspective view showing removable brackets attachable to respective arms of a bracket.

FIG. 5 is a bottom perspective view of a suction cup assembly according to the present invention.

FIG. 6 is an exploded view of FIG. 5.

FIG. 7 is a plan view of a bracket according to the invention, with a portion of one of the brackets broken away to depict locking teeth.

FIG. 8 is a rear-elevational view of FIG. 7.

FIG. 9 is a plan view of a spring finger shown in FIG. 7.

FIG. 10 is a plan view of an alternative type of spring finger.

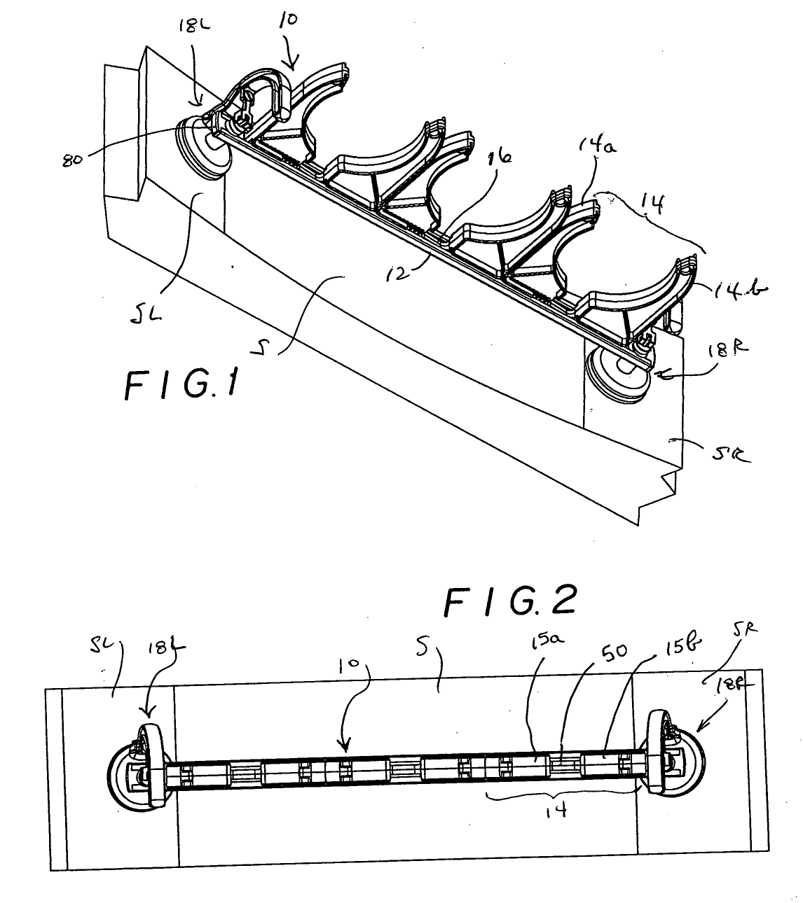

### DESCRIPTION OF PREFERRED EMBODIMENTS OF THE INVENTION

A portable gas-tank holder 10 comprises a rigid frame in the form of a rail 12 in which at least one bracket 14 is mounted. Each bracket 14 includes two releasably interconnected parts 14a, 14b. Each bracket part 14a, 14b includes a base 15a, 15b that is slidable in a longitudinal slot 16 of generally T-shaped cross-section formed by the rail. Two suction cup assemblies 18R, 18L are disposed at respective ends of the rail for releasably securing the rail to the surface of a vertical wall.

Each bracket 14 part 14a, 14b includes a curved arm 17a, 17b integral with the respective base 15a, 15b, the arms arranged to form a pocket 24 into which a gas tank can be positioned. The bracket parts 14a, 14b can be mounted to the rail 12 only by being slid into one or the other ends of the slot 16. Afterwards, the respective suction cup assembly 18R, 18L is mounted to the rail, blocking removal of the brackets. To remove one or more of the brackets, one of the suction cup assemblies would have to be removed.

It is desirable to be able to adjust the size of the pocket of each bracket, in order to adapt the pocket to differently sized tanks. Such adjustment is particularly necessary in cases where there is no upright surface shaped appropriately for receiving the suction cups. In such cases, it may be necessary to attach the suction cups to a horizontal floor, but then it is necessary for the tank to be held tightly within its pocket to keep the tank from sliding out. Hence, the ability to adjust the pocket size becomes especially important in those cases. To adjust the pocket size in the prior art, it is proposed that the arms comprise separate members that are releasably interconnected by intermeshing teeth which can be decoupled to allow the arms to be adjusted toward or away from one another. However, it is required that the arms be removed from the rail in order to decouple the teeth (see U.S. Pat. No. 5,333,701). That would create an inconvenience if it also required the removal of a suction cup assembly.

In order to enable such adjustment to be made without having to remove the bracket from the rail, and thus without having to remove one of the suction cup assemblies, the present invention provides an arrangement wherein the bracket parts 14a, 14b can be adjusted toward and away from one another while disposed in the rail, i.e., wherein a locking mechanism which holds the arms in their adjusted positions can be released and reengaged while the arms are disposed in the rail.

The preferred locking mechanism comprises two rows of teeth, namely a row of teeth 32 disposed on the base 15b of the bracket part 14b, and a row of teeth 30 disposed on a spring finger 34 integral with the base 15a of the bracket part 14a. The teeth 30 are situated in the slot 16 and project toward the pocket 24, whereas the teeth 32 project toward the teeth 30 so as to mesh therewith in order to lock the bracket parts 14a, 14b against movement toward or away from one another. Thus, either row of teeth can be considered as forming recesses which receive projections defined by the other row of teeth.

The spring arm 34 is biased elastically toward the base 15b of the bracket part 14b so the teeth 30, 32 tend to be meshed. However, the spring arm can be displaced away from the base 15b by a pushing force while the bracket is disposed in the slot, thereby disengaging the teeth and enabling the bracket parts to be moved toward or away from one another within the slot 16. When the pushing force is released, the spring finger snaps back toward the base 15b to re-engage the teeth 30, 32 and lock the arms in their newly adjusted position.

In order to enable the teeth 30 of the spring finger 34 to be flexed out of engagement with the teeth 32, the base 15b is provided with a horizontal through-slot 50 that extends entirely through the base 15b and centrally through the row of teeth 32, thereby exposing the portion of the spring finger 34 on which the teeth 30 are formed. That enables a suitable tool (not shown) to be inserted through the through-slot 50 in direction D and into engagement with the spring finger 34 to elastically press the teeth 30 of the spring finger out of engagement with the teeth 32. With the teeth 30, 32 thus held out of interengagement, the base parts 14a, 14b can be slid toward or away from one another to adjust the pocket size. Then, the spring arm 34 would be released to snap back toward the base 15b and re-couple the teeth.

The spring finger 34 could be formed integrally with the base 15a with the elasticity thereof produced by inherent flexibility of the thus-cantilevered spring finger. Alternatively, the elasticity could be provided by a separate spring (e.g., a coil spring 40) interposed between the spring finger and an integral support strip 42 of the base 15a, as shown in FIG. 10.

As an additional alternative (not shown), the spring finger need not be formed integrally with the arm 20, but rather could comprise a separate member displaceable relative to the arm 20 and spring biased in a direction producing a meshing of the teeth.

Thus, it is possible to adjust the size of the pocket 24 formed by any selected bracket 14 without having to remove the bracket from the rail 12 and thus without having to remove one of the suction cup assemblies 18.

The suction cup assemblies 18R, 18L are identical, each including a rigid base 60 having a round cup-shaped portion 62. The cup shape is formed by a recess (not shown) in a front side thereof, which recess is covered by a suction cup in the form of an elastic suction disc 64 formed of suitable plastic or rubber. A rigid shaft 66 projects rearwardly from the disc and extends through a corresponding through-hole 68 of the base 62. Preferably, the shaft and through-hole are of non-circular cross-sectional shape to prevent relative rotation therebetween. A coil compression spring 70 is disposed between the disk 64 and a floor of the front recess of the base. A manual lever 72 is provided in order to pull the shaft 66, and thus the disc 64, toward the base 60. Thus, the disc will be pulled into the recess of the base, thereby deforming the disc into a cup shape for creating a suction between an outer surface of the disc (i.e., a surface facing away from the base 60) and a support surface (e.g., a wall of a boat) against which that disc outer surface engages. A gripping handle is attached to the base 62 to enable the suction cup assembly to be more easily carried.

Each suction cup assembly 18R, 18L includes a slide, preferably in the form of an end cap 76 which enables the suction cup assembly to be mounted to the rail. The end cap includes a slide portion 78 configured to slide within the slot 16 of the rail, and a stop portion 80 which bears against an end face of the rail to cover the end of the slot (see the left side of FIG. 1). The slide portion includes a through-hole 82 through which the shaft 66 extends. Elastic washers 84, 86 are disposed at respective opposite ends of the through-hole 82 for reasons to be explained.

The lever 72 includes a fork 88 into which the shaft 66 extends. The legs of the fork 88 have aligned pin holes 89 which are alignable with a pin hole 90 of the shaft, enabling a fastener pin 92 to be inserted through the pin holes for connecting the shaft 66 to the lever 72. Of course, since the end cap 76 is to be slid into an end of the rail slot 16, a hole will be formed in the rail through which the shaft 66 extends once such hole is aligned with the through-hole 82 of the end cap 76.

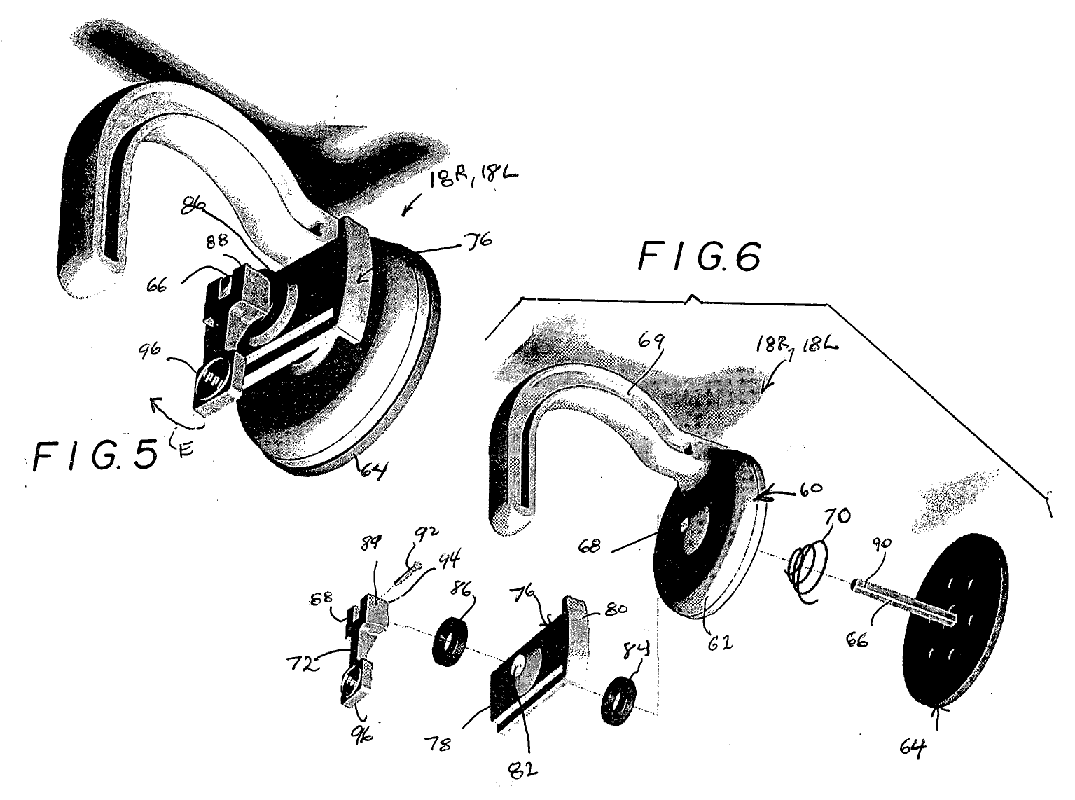

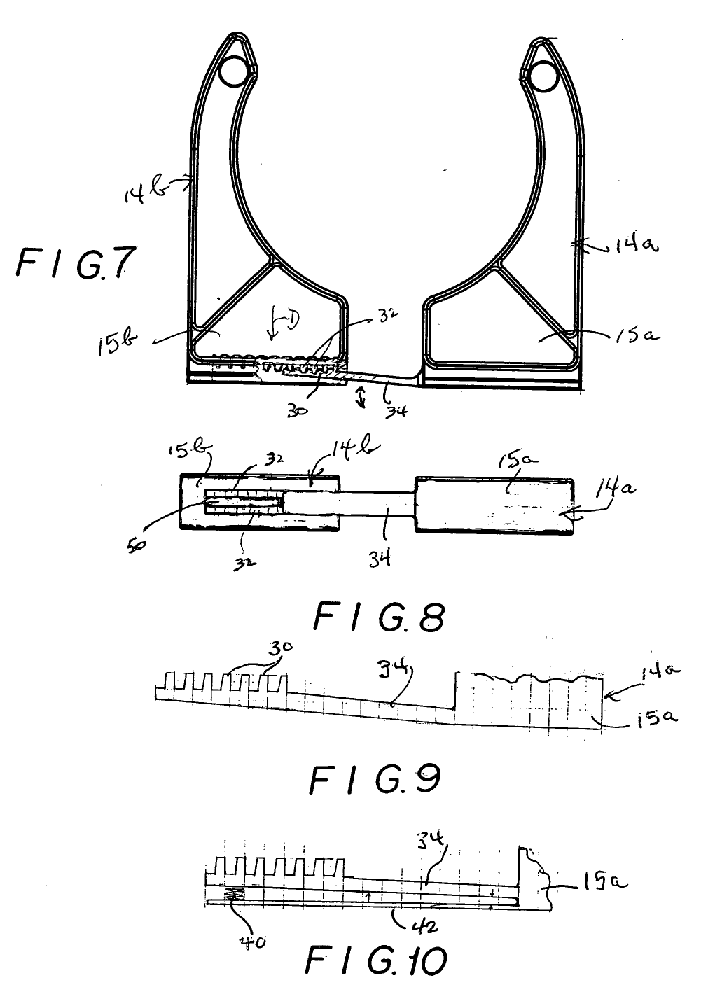

When the components of the suction cup assembly have been assembled as shown in FIG. 5 (which figure omits the rail 12), it will be appreciated that a corner 94 of the fork 88 (see FIG. 6) is adapted to engage the washer 86 and to slide along the washer between first and second positions when the lever 72 is rotated by 90° about the axis of the pin in the direction E shown in FIG. 5. Such rotation occurs as manual pressure is applied to a grip section 96 of the lever 72. It will be appreciated that when the lever 72 extends in general alignment with the shaft, i.e., after the grip portion 96 of the lever is rotated by 90° clockwise (direction E) from the position shown in FIG. 5, the corner 94 will engage a portion of the washer 86 shown in FIG. 5, and the shaft 66 will have been displaced to the right in FIG. 4, thereby pushing the disk 64 out of the front recess of the base and breaking the suction between the disk 64 and a support surface against which the disk had been adhered. By thereafter rotating the grip portion 96 (counterclockwise in FIG. 5), the corner 94 will slide upwardly along the washer 86, causing the pin 92 to be cammed in a direction away from the base 62. Thus, the shaft will be pulled to the left in FIG. 5, i.e., opposite the direction E, causing the disc 64 to be pulled into the front recess of the base 60 and deformed into a cup shape to generate a suction against a support wall.

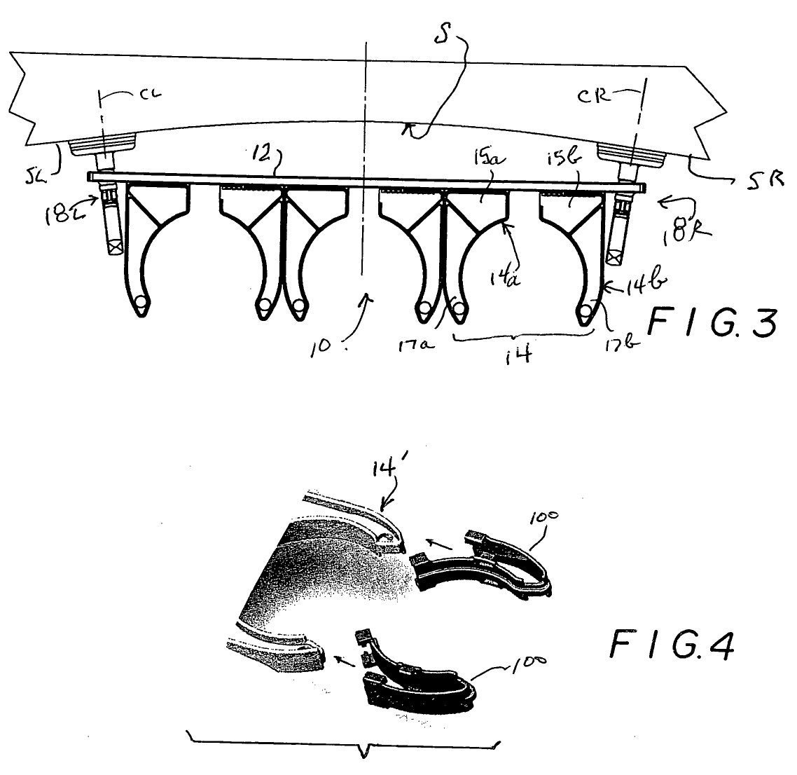

Importantly, the suction cups (i.e., the disks 64) are able to be attached to respective portions of the support wall which are not co-planar. For example, the suction cup assemblies 18R, 18L are able to be secured to respective portions SR, SL of a curved support surface S. That is accomplished by enabling the shaft 66 of each suction cup assembly to swing freely relative to the rail 12, and relative to each other, preferably in all directions, whereby the center axes CR and Cl, respectively, of the suction cup assemblies 18R, 18L assume a non-parallel relationship as shown in FIG. 3. Such swinging ability of the shafts 66 can be effected in numerous ways, but a particularly economical and effective way involves making the through-hole 82 of the end cap, and the corresponding through-hole of the rail, of larger size than the cross section of the shaft 66. Thus, the shaft 66 can swing freely in its respective oversized through-hole 82, while the washers 84, 86 deform elastically as they are tightly pressed against the rail 16 and the lever 76, respectively, to eliminate any looseness (i.e., rattling) between the rail and the suction cup assemblies.

When the holder has been attached to the support wall, gas tanks can be inserted downwardly into the pockets 24 of the brackets. Preferably, the holder is positioned close enough to a floor to enable the bottoms of the tanks to rest on the floor. It will be appreciated that the gas tanks are now secured against movement by the holder 10.

If necessary, the size of the pockets can be adjusted by pushing the spring finger 34 in a direction away from the pocket, thereby temporarily disengaging the teeth 30, 32 and enabling the bracket parts 14a, 14b to be adjusted toward or away from one another.

In lieu of, or in addition to, providing a bracket having relatively movable bracket parts for adjusting the size of the pocket, there could be provided in accordance with the present invention a pair of clip-on elements 100 which could be releasably clipped onto the arms of a bracket 14′ as shown in FIG. 4. Those brackets would reduce the size of the pocket in order to adapt the pocket for receiving different-size elements, e.g., a speargun.

The portable holder according to the afore-described embodiments of the invention is especially beneficial to scuba divers who can use the holder on a boat that does not come equipped with adequate means for securing gas tanks. There is no need to form unsightly holes in the boat hull or to risk any water leakage that might result from such holes.

The portable holder can also be used in any type of facility that uses gas tanks, such as hospitals and welding shops for example, in order to provide a temporary tank-holding ability anywhere at the facility. The holder could also be temporarily attached to the sidewall of a pick-up truck bed during transport of gas tanks.

The holder can also be attached to a non-planar surface, since the suction cup assemblies are independently swingable relative to the rail.

Any suitable number of tank-holding brackets 14 could be used, although one to four of such brackets are preferably employed.

Preferably, two suction cups are employed, although possibly more, could be employed instead.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

What is claimed is:

1. A gas tank holder for securing at least one cylindrical compressed gas tank to a support surface, comprising:
a frame securable to the support surface;
at least one bracket slidably mounted in the frame and including:
first and second bracket parts arranged to form together a pocket, the first and second bracket parts arranged for movement toward and away from one another to adjust the size of the pocket, and
a locking mechanism for coupling the first and second bracket parts together in their adjusted position and being releasable while the first and second arms are mounted in the frame to enable the first and second arms to be adjusted; and
at least one suction cup attached to the frame for removably securing the frame to the support surface.

2. The gas tank holder according to claim 1 wherein the locking mechanism comprises a finger disposed on the first bracket part and movable toward and away from the second bracket part.

3. The gas tank holder according to claim 2 wherein the finger comprises a spring finger biased toward the second bracket part.

4. The gas tank holder according to claim 3 wherein the spring finger includes at least one projection engageable selectively in recesses formed in the second bracket part.

5. The gas tank holder according to claim 4 wherein the spring finger is movable in a direction away from the pocket in order to release the first and second bracket parts from one another.

6. The gas tank holder according to claim 5 wherein the second bracket part includes a through slot for enabling a tool to be pushed against the spring finger to displace the spring finger.

7. The gas tank holder according to claim 2 wherein the finger includes at least one projection engageable selectively in recesses formed in the second bracket part.

8. The gas tank holder according to claim 2 wherein the finger is movable in a direction away from the pocket in order to release the first and second bracket parts from one another.

9. The gas tank holder according to claim 1 wherein the locking mechanism comprises a spring finger disposed on the first bracket part and having first teeth formed thereon, the spring finger biased elastically toward second teeth formed on the second bracket part.

10. The gas tank holder according to claim 1 wherein the frame comprises a rail having a longitudinal slot formed therein, each of the first and second bracket parts being slidable within the slot, the second teeth disposed in the slot and projecting away from the pocket, the first teeth disposed in the slot and projecting toward the pocket.

11. The gas tank holder according to claim 1 wherein the frame comprises a rail having a slot in which the at least one bracket is slidably disposed.

12. The gas tank according to claim 11 wherein there is a plurality of suction cups each suction cup mounted on an end cap which slides onto a respective end of the rail.

13. The gas tank holder according to claim 12 wherein each suction cup is connected to a manually actuable suction release valve.

14. The gas tank holder according to claim 1 wherein there is a plurality of suction cups, each suction cup mounted on a shaft, the shafts being swingable relative to the frame to enable the suction cups to be mounted on respective support surface sections that are non-co-planar.

15. A portable gas tank holder for securing at least one cylindrical compressed gas tank to a support surface, comprising:
a frame having at least one receiving pocket,
at least two suction cup assemblies attached to the frame for removably securing the frame to the surface, and each suction cup assembly comprising:
an elastically flexible suction disc disposed at a front side of the frame and being engageable with the support surface for retaining the frame thereto by suction; and
a shaft for connecting the flexible disc to the frame, the shaft defining a center axis of the suction cup assembly and being separately swingable relative to the frame to enable the center axes of the respective suction cup assemblies to assume a non-parallel relationship when attaching the suction discs to respective sections of the support surface that are non-co-planar.

16. The portable gas tank holder according to claim 15 wherein the frame comprises a rail having a longitudinal slot formed in a rear side thereof opposite the front side, each suction cup assembly further comprising:
a base disposed at the front side of the frame and including a first through hole, the shaft passing through the first through-hole and through a second through-hole formed in the frame, the base including a forwardly facing recess into which the disc can be pulled to assume a concave shape,
a slide slidably disposed in the slot and including a third through-hole through which the shaft passes,
a lever disposed on a rear end of the shaft for displacing the shaft and the disc forwardly and rearwardly,
a first elastic washer sandwiched between the lever and the slide, and a second elastic washer sandwiched between the slide and the base,
wherein the second and third through-holes having a larger cross-section than the shaft to enable the swinging movement thereof.

17. The portable tank holder according to claim 16 wherein the slide includes a stop portion bearing against a respective end of the rail to limit an extent of sliding movement of the slide within the slot.

18. A holder for securing an element to a support surface, comprising:
a frame securable to the support surface;
at least one bracket slidably mounted in the frame and including:
first and second arms arranged to form together a tank-receiver pocket, and
first and second removable clip-on members arranged to be clipped onto the first and second arms, respectively, for reducing a size of the pocket; and
at least one suction cup attached to the frame for removably securing the frame to the support surface.
